(19) United States
(12) Patent Application Publication
(10) Pub. No.: US 2026/0124862 A1
(43) Pub. Date: May 7, 2026

(54) MOVABLE TOW HOOK ASSEMBLIES AND VEHICLES INCLUDING SAME

(71) Applicant: Toyota Motor Engineering & Manufacturing North America, Inc., Plano, TX (US)

(72) Inventors: Aaron R. Steinhilb, Milan, MI (US); Joseph C. Taylor, Ypsilanti, MI (US); Jon B. Glass, Westland, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/938,700

(22) Filed: Nov. 6, 2024

(51) Int. Cl. B60D 1/04; B60D 1/24; B60D 1/54; B60D 1/56

(52) U.S. Cl. CPC B60D 1/04; B60D 1/243; B60D 1/54; B60D 1/565

(57) ABSTRACT

A tow hook assembly including a housing including a front wall, a front aperture formed in the front wall, and a detent formed in the housing, the detent defining a curved surface portion, and a tow hook at least partially extending through the front aperture of the housing, the tow hook movable between an extended position and a retracted position, the tow hook including a biasing member received within a biasing channel formed in the tow hook and a bearing provided at an end of the biasing member, the biasing member biasing the bearing into the detent when the tow hook is in the extended position, the biasing member prohibiting movement of the tow hook from the extended position to the retracted position until a force exceeding a predetermined force threshold in a direction opposite a towing direction is applied against a front end of the tow hook.

### TECHNICAL FIELD

The present specification generally relates to tow hooks for vehicles and, more specifically, tow hooks that are configured to reduce contact with a barrier during a collision.

### BACKGROUND

Current tow hooks may attach or be fixed to a vehicle at different connection points so that the tow hook is operable to remain on the vehicle while a towing force in a towing direction is applied to the tow hook. However, during a collision, the tow hook may contact an obstacle and apply a force in a direction opposite the towing direction that may cause further damage to internal components of the vehicle located rearward of the tow hook and to the obstacle.

Accordingly, a need exists for improved tow hooks that reduce damage to components of the vehicle as well as to an object contacted by the vehicle during the collision.

### SUMMARY

In one embodiment, a tow hook assembly includes a housing including a front wall, a front aperture formed in the front wall, and a detent formed in an inner surface of the housing, the detent defining a curved surface portion, and a tow hook at least partially extending through the front aperture of the housing, the tow hook movable between an extended position and a retracted position relative to the housing, the tow hook including a biasing member received within a biasing channel formed in the tow hook and a bearing provided at an end of the biasing member, the biasing member biasing the bearing into the detent when the tow hook is in the extended position, the biasing member prohibiting movement of the tow hook from the extended position to the retracted position until a force exceeding a predetermined force threshold in a direction opposite a towing direction is applied against a front end of the tow hook.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vehicle including a pair of tow hook assemblies, according to one or more embodiments shown and described herein;

FIG. 2 schematically depicts a partial cross-sectional side view of the tow hook assembly including a tow hook in an extended position, according to one or more embodiments shown and described herein;

FIG. 3 schematically depicts a partial cross-sectional side view of the tow hook assembly including the tow hook in an intermediate position, according to one or more embodiments shown and described herein;

FIG. 4 schematically depicts a partial cross-sectional side view of the tow hook assembly including the tow hook in a retracted position, according to one or more embodiments shown and described herein;

FIG. 5 schematically depicts a partial cross-sectional side view of another tow hook assembly including a tow hook in an extended position, according to one or more embodiments shown and described herein; and

FIG. 6 schematically depicts a partial cross-sectional side view of the tow hook assembly of FIG. 5 including the tow hook in a retracted position, according to one or more embodiments shown and described herein.

### DETAILED DESCRIPTION

Embodiments described herein are directed to movable tow hook assemblies and vehicles including movable tow hook assemblies. The tow hook assembly includes a housing having a front aperture formed in a front wall of the housing, a tow hook at least partially extending through the front aperture and movable between an extended position and a retracted position, and a biasing member configured to prohibit movement of the tow hook from the extended position to the retracted position until a force exceeding a predetermined force threshold is applied against a front end of the tow hook in a direction opposite a towing direction. Various embodiments of the apparatus and operation of the apparatus are described in more detail herein. Whenever possible, the same reference numerals will be used throughout the drawings to refer to the same or like parts.

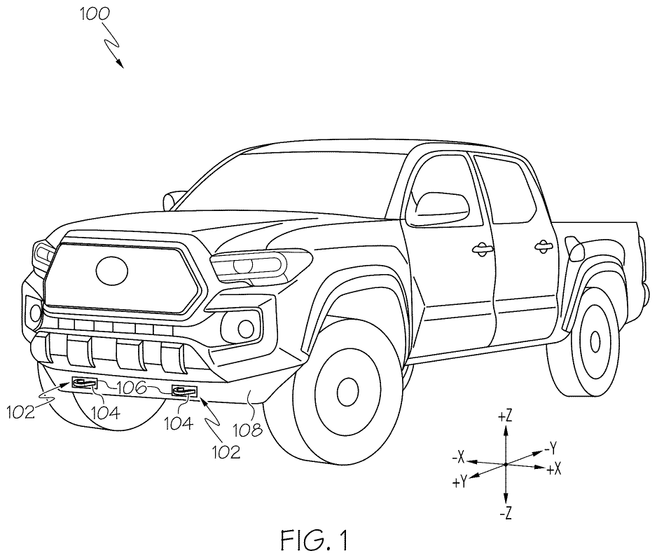

As used herein, the term “vehicle longitudinal direction” refers to the forward-rearward direction of the vehicle (i.e., in the +/−Y direction of the coordinate axes depicted in FIG. 1). The term “vehicle lateral direction” refers to the cross-vehicle direction (i.e., in the +/−X direction of the coordinate axes depicted in FIG. 1), and is transverse to the vehicle longitudinal direction. The term “vehicle vertical direction” refers to the upward-downward direction of the vehicle (i.e., in the +/−Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

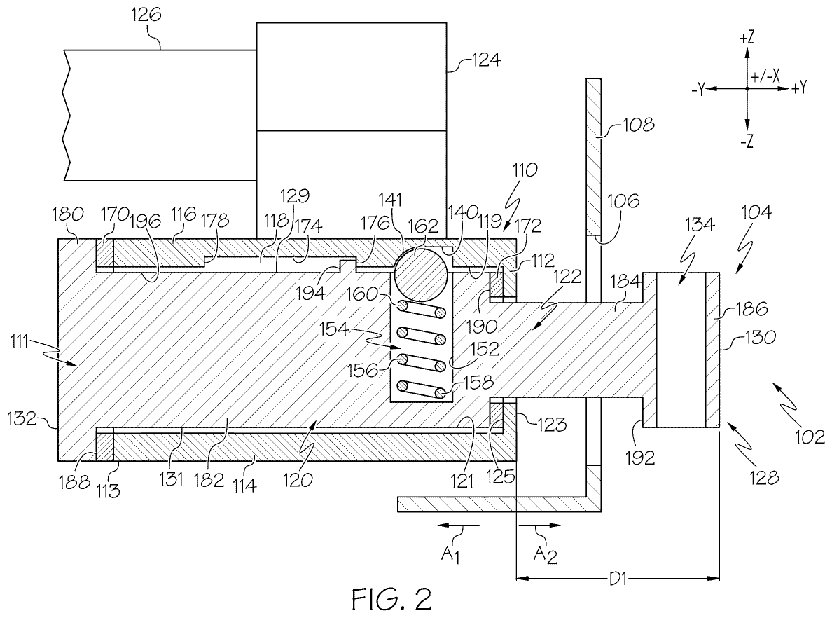

Referring now to FIG. 1, a perspective view of a vehicle 100 is depicted. As used herein, a vehicle 100 may refer to any instrument that is operable to transport people and/or goods from one location to another. For example, the vehicle 100 may include, but is not limited to, an automobile, car, bus, truck, boat, and the like. The vehicle 100 may comprise one or more tow hook assemblies 102. As shown in FIG. 1, the vehicle 100 includes a pair of tow hook assemblies 102. Each tow hook assembly 102 may be connected to any portion of the vehicle 100. For example, in some embodiments, the tow hook assemblies 102 may be attached to a frame member 124 or bumper beam of the vehicle 100, as shown in FIG. 2.

More particularly, in embodiments, the tow hook assemblies 102 may be attached to extend above the frame member 124 of the vehicle 100. In other embodiments, the tow hook assemblies 102 may be attached to extend below the frame member 124 of the vehicle 100. For example, the tow hook assemblies 102 may be positioned to extend below the frame member 124 of the vehicle 100 such that a tow hook of the tow hook assembly 102 may be configured to receive a tow strap extending in a vehicle longitudinal direction below the frame member 124 of the vehicle 100.

In some embodiments, as shown in FIG. 1, the tow hook assemblies 102 may include a tow hook 104 extending in the vehicle longitudinal direction such that at least a portion of the tow hook 104, which is mounted to a vehicle body component as described in greater detail below, extends through an opening 106 formed in a bumper cover 108. The bumper cover 108 is positioned forward of the frame member 124 in the vehicle longitudinal direction such that the frame member 124 is not illustrated in FIG. 1.

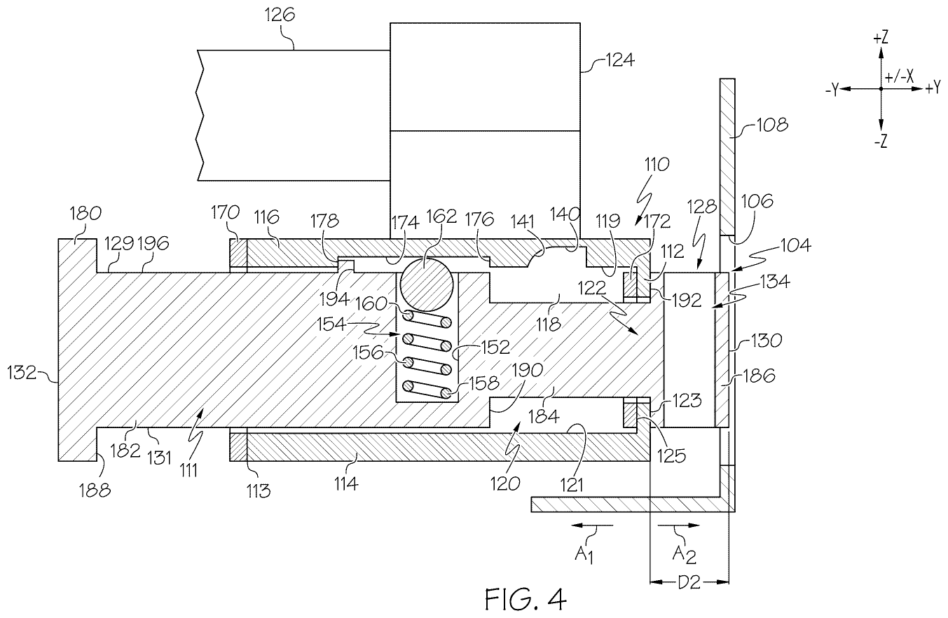

Referring now to FIG. 2, the tow hook assembly 102 includes a housing 110 and the tow hook 104. The housing 110 includes a front wall 112, a lower wall 114, a mounting plate or upper wall 116 opposite the lower wall 114, and a pair of side walls 118 that define an open interior 120. The front wall 112 includes a front surface 123 and a rear surface 125 opposite the front surface 123. In embodiments, the housing 110 is a one-piece, monolithic structure. In other embodiments, the upper wall 116 is separately attached to the front wall 112 and the pair of side walls 118. In other embodiments, each of the front wall 112, the lower wall 114, the upper wall 116, and the pair of side walls 118 are separately attached to one another. Accordingly, in embodiments, the housing 110 may not be a one-piece, monolithic structure. A rear aperture 111 is formed in a rear end 113 of the housing 110, and a front aperture 122 is formed in the front wall 112 opposite the rear aperture 111 to permit the tow hook 104 to move between an extended position, as shown in FIG. 2, and a retracted position, as shown in FIG. 4, relative to the housing 110. Accordingly, the rear aperture 111 and the front aperture 122 have any suitable geometry corresponding to a shape of the tow hook 104, for example, circular, rectangular, or other regular or irregular shapes.

In embodiments, the housing 110 includes one or more seals to prevent debris from entering the open interior 120 of the housing 110 when the tow hook 104 is in the extended position, as described in more detail herein. As shown in FIG. 2, a first seal 170 is provided on the rear end 113 of the housing 110, and a second seal 172 is provided on the rear surface 125 of the front wall 112. In embodiments, the first seal 170 and the second seal 172 each extend along an entire inner surface of the housing 110. Accordingly, the first seal 170 and the second seal 172 have a geometry corresponding to the inner surface of the housing 110, for example, circular, rectangular, or any other suitable regular or irregular shape. The first seal 170 and the second seal 172 may be formed of any suitable material, for example, rubber, neoprene, polyvinyl chloride (PVC), silicone, polyurethane foam, thermoplastic elastomers (TPE), and the like.

A detent 140 is formed in the housing 110. As shown in FIG. 2, the detent 140 is formed on an inner surface 119 of the upper wall 116 of the housing 110. In embodiments, the detent 140 is formed closer to the front wall 112 of the housing 110 than to the rear end 113 of the housing 110. In embodiments, the detent 140 defines a curved surface portion 141 facing the front aperture 122 of the housing 110. The curved surface portion 141 extends to the inner surface 119 of the upper wall 116 of the housing 110. In embodiments, the curved surface portion 141 extends substantially half a length of the detent 140 in the vehicle longitudinal direction. It should be appreciated that the detent 140 may instead be formed on an inner surface 121 of the lower wall 114 or one of the side walls 118 of the housing 110. Additionally, in embodiments, a plurality of detents 140 may be formed in any combination of the upper wall 116, the lower wall 114, and/or the side walls 118.

As shown in FIG. 2, in embodiments, a groove 174 is formed in the housing 110. As shown in FIG. 2, the groove 174 is formed on the inner surface 119 of the upper wall 116 of the housing 110. It should be appreciated that the groove 174 may instead be formed on the inner surface 121 of the lower wall 114 or one of the side walls 118 of the housing 110. Additionally, in embodiments, a plurality of grooves 174 may be formed in any combination of the upper wall 116, the lower wall 114, and/or the side walls 118. The groove 174 extends parallel to the vehicle longitudinal direction and has a front end 176 and a rear end 178 opposite the front end 176. The front end 176 of the groove 174 is closer to the front wall 112, the housing 110 than to the rear end 113 of the housing 110, and the rear end 178 of the groove 174 is closer to the rear end 113 of the housing 110 than to the front wall 112 of the housing 110. As shown, the groove 174 is formed between the detent 140 and the rear end 113 of the housing 110. However, in other embodiments, the groove 174 may be formed between the detent 140 and the front wall 112 of the housing 110.

Referring still to FIG. 2, the housing 110 is mounted to a frame member 124, such as the bumper beam, a crush box, or the like, in any suitable manner, for example, mechanical fasteners, clips, adhesive, welding, or the like. In embodiments, the upper wall 116 of the housing 110 is fixed to the frame member 124. As shown in FIG. 2, the frame member 124 is provided rearward of the bumper cover 108. A longitudinal rail 126 extends from the frame member 124 in the vehicle longitudinal direction opposite the bumper cover 108.

The tow hook 104 includes a tow hook body 128 having a front end 130 and a rear end 132 opposite the front end 130, an upper surface 129, and a lower surface 131 opposite the upper surface 129. In embodiments, the tow hook body 128 includes a rear end portion 180 formed at the rear end 132, an elongated portion 182 extending from the rear end portion 180, a neck portion 184 extending from the elongated portion 182 opposite the rear end portion 180, and a front end portion 186 formed at the front end 130 extending from the neck portion 184 opposite the elongated portion 182.

The rear end portion 180 includes a front surface 188 intersecting the elongated portion 182, the elongated portion 182 includes a front surface 190 intersecting the neck portion 184, and the front end portion 186 includes a rear surface 192 intersecting the neck portion 184. As shown, a height of the rear end portion 180 extending in the vehicle vertical direction is greater than a height of the elongated portion 182 extending in the vehicle vertical direction, which is greater than a height of the neck portion 184 extending in the vehicle vertical direction. Additionally, in embodiments, a height of the front end portion 186 extending in the vehicle vertical direction is greater than the height of the neck portion 184.

In embodiments, the first seal 170 may be formed on the front surface 188 of the rear end portion 180 rather than the rear end 113 of the housing 110, and the second seal 172 may be formed on the front surface 190 of the elongated portion 182 of the tow hook body 128 rather than the rear surface 125 of the front wall 112 of the housing 110.

As discussed herein, an outer peripheral shape of the neck portion 184 of the tow hook body 128 has a shape corresponding to the front aperture 122 formed in the front wall 112 of the housing 110 such that the tow hook body 128 is permitted to move through the front aperture 122 and within the open interior 120 of the housing 110.

In embodiments, a biasing channel 152 is formed within the tow hook body 128 and extends at least partially through the tow hook body 128 in the vehicle vertical direction. As shown in FIG. 2, the biasing channel 152 is formed within the elongated portion 182 of the tow hook body 128 proximate the front surface 190 of the elongated portion 182, i.e., closer to the front surface 190 of the elongated portion 182 than to the front surface 188 of the rear end portion 180 of the tow hook body 128. In other embodiments, the biasing channel 152 is formed within the elongated portion 182 of the tow hook body 128 proximate the front surface 188 of the rear end portion 180 of the tow hook body 128, i.e., closer to the front surface 188 of the rear end portion 180 than to the front surface 190 of the elongated portion 182. Additionally, as shown in FIG. 2, the biasing channel 152 is formed to extend only partially through the tow hook body 128 in the vehicle lateral direction and through the upper surface 129 of the tow hook body 128.

A biasing member 154 is received within the biasing channel 152. In embodiments, the biasing member 154 includes a spring 156 having a first end 158 and a second end 160 opposite the first end 158, and a bearing 162 provided at the second end 160 of the spring 156. In embodiments, the spring 156 is a coil spring. In other embodiments, the spring 156 is a resilient elastomeric member such as a compressible rubber, resilient plastic, or the like. In embodiments in which the detent 140 is formed in the lower wall 114 of the housing 110, the biasing channel 152 may alternatively extend through the lower surface 131 of the tow hook body 128. In embodiments, the curved surface portion 141 has a curvature corresponding to a curvature of the bearing 162. Accordingly, as described in more detail herein, the curved surface portion 141 provides a smooth transition for the bearing 162 to exit the detent 140.

In embodiments in which the groove 174 is formed in the upper wall 116 of the housing 110, a rib 194 extends from an upper surface 196 of the elongated portion 182 to be received within the groove 174. As shown in FIG. 2, the rib 194 is formed between the biasing channel 152 and the rear end portion 180. However, in other embodiments, the rib 194 is formed between the biasing channel 152 and the front end portion 186.

In embodiments, a hole 134 is formed in the tow hook body 128 proximate the front end 130 and within the front end portion 186 to permit an attachment member, for example, a towing strap, hitch, or the like, to be secured to the tow hook 104. In other embodiments, the front end 130 of the tow hook body 128 itself may have any suitable shape or size, for example, a curved or hooked portion such that a tow strap may be secured directly thereto. In some embodiments, the front end 130 of the tow hook body 128 has the shape of a hook.

It should be appreciated that when the tow hook 104 is positioned in the extended position, as shown in FIG. 2, the tow hook body 128 extends through the opening 106 formed in the bumper cover 108 such that the hole 134 formed in the tow hook body 128 is entirely positioned at an exterior side of the vehicle 100.

Additionally, as shown in FIG. 2, when the tow hook 104 is in the extended position, the first seal 170 provided on the rear end 113 of the housing 110 abuts against the front surface 188 of the rear end portion 180 of the tow hook body 128, and the second seal 172 provided on the rear surface 125 of the front wall 112 of the housing 110 abuts against the front surface 190 of the elongated portion 182 of the tow hook body 128. Alternatively, when the first seal 170 and the second seal 172 are provided on the tow hook body 128 and the tow hook 104 is in the extended position, the first seal 170 provided on the front surface 188 of the rear end portion 180 of the tow hook body 128 abuts against the rear end 113 of the housing 110, and the second seal 172 provided on the front surface 190 of the elongated portion 182 abuts against the rear surface 125 of the front wall 112 of the housing 110. As noted above, the first seal 170 and the second seal 172 prevent water and debris from entering the open interior 120 of the housing 110 when the tow hook 104 is in the extended position. Specifically, the first seal 170 is compressed between the rear end portion 180 of the tow hook body 128 and the rear end 113 of the housing 110, and the second seal 172 is compressed between the front surface 190 of the elongated portion 182 and the front wall 112 of the housing 110 to seal the open interior 120 of the housing 110.

Moreover, as shown in FIG. 2, when the tow hook 104 is in the extended position, the spring 156 of the biasing member 154 forces the bearing 162 into the detent 140. Additionally, when the tow hook 104 is in the extended position, the rib 194 abuts against the front end 176 of the groove 174. Accordingly, it should be appreciated that the stroke of the tow hook in the +Y direction relative to the housing 110 is limited by contact of the front surface 188 of the rear end portion 180 with the first seal 170, contact of the front surface 190 of the elongated portion 182 with the rear surface 125 of the front wall 112 of the housing 110, and/or contact of the rib 194 with the front end 176 of the groove 174.

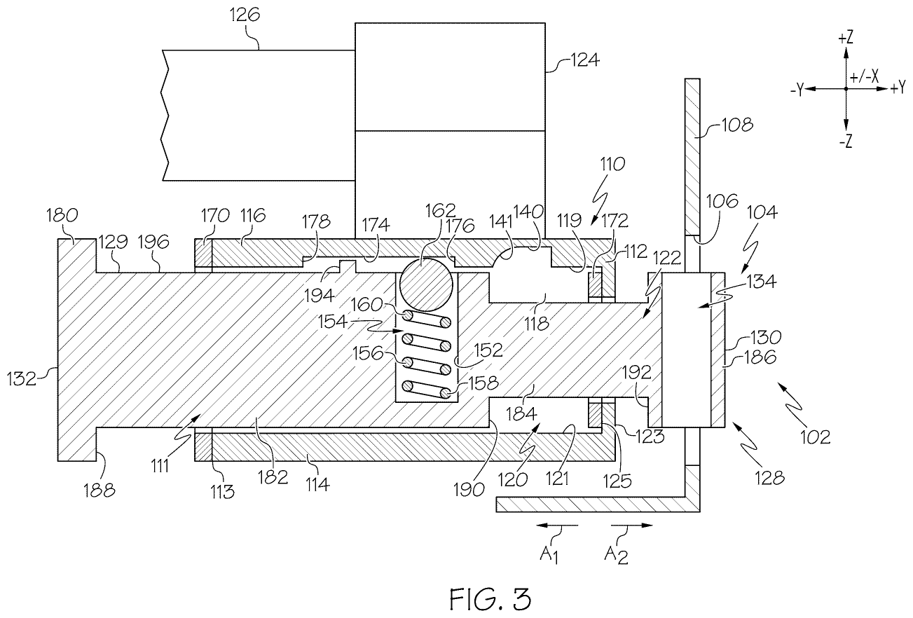

Referring now to FIG. 3, the tow hook 104 is shown positioned in an intermediate position. Specifically, when a force exceeding a predetermined threshold is applied against the front end 130 of the tow hook body 128, the biasing member 154 is compressed such that the bearing 162 of the biasing member 154 is drawn out of the detent 140. More particularly, the curved surface portion 141 of the detent 140 provides a smooth transition for the bearing 162 moving out of the detent 140 as the bearing 162 forces the biasing member 154 to compress. With the bearing 162 removed from the detent 140, the tow hook body 128 is permitted to move rearwardly in the vehicle longitudinal direction, as depicted by arrow A1, which indicates a direction opposite a towing direction.

As described herein, the tow hook 104 is moved out of the extended position upon a force exceeding a predetermined threshold being applied against the front end 130 of the tow hook body 128. In embodiments, the predetermined force threshold is 1 kilonewton (kN) +/−10%. In embodiments, the predetermined force threshold is 1 kN +/−20%. In embodiments, the predetermined force threshold is 1 kN +/−30%. In embodiments, the predetermined force threshold is 1 kN +/−40%. In embodiments, the predetermined force threshold is 1 kN +/−50%. In embodiments, the predetermined force threshold is 10 kN +/−10%. In embodiments, the predetermined force threshold is 10 kN +/−20%. In embodiments, the predetermined force threshold is 10 kN +/−30%. In embodiments, the predetermined force threshold is 10 kN +/−40%. In embodiments, the predetermined force threshold is 10 kN +/−50%.

When the tow hook 104 is positioned in the retracted position, as shown in FIG. 4, the tow hook 104 is further received within the open interior 120 of the housing 110 such that a distance D2 between the front end of the tow hook body 128 and the front wall 112 of the housing 110 is less than a distance D1 between the front end 130 of the tow hook body 128 and the front wall 112 of the housing 110 when the tow hook 104 is in the extended position, as shown in FIG. 2. Stated another way, when the tow hook 104 is in the extended position, as shown in FIG. 2, the tow hook 104 extends farther outward from the housing 110 than when the tow hook 104 is in the retracted position, as shown in FIG. 4.

As shown in FIG. 4, when the tow hook 104 is in the retracted position, the rear surface 192 of the front end portion 186 abuts against the front surface 123 of the front wall 112 of the housing 110. Additionally, when the tow hook 104 is in in the retracted position, the rib 194 abuts against the rear end 178 of the groove 174. Accordingly, it should be appreciated that the stroke of the tow hook 104 in the −Y direction relative to the housing 110 is limited by contact of the rear surface 192 of the front end portion 186 of the tow hook body 128 with the front surface 123 of the front wall 112 of the housing 110 and/or contact of the rib 194 with the rear end 178 of the groove 174. In other words, the amount of stroke permitted by the tow hook 104 is limited to a distance between the front surface 190 of the elongated portion 182 and a rear surface 192 of the front end portion 186 and/or a length of the groove 174. In other embodiments, the amount of stroke permitted by the tow hook 104 may be limited by a combination of the rib 194 and the front end portion 186. As a non-limiting example, stroke in the +Y direction may be limited by the rib 194 contacting the front end 176 of the groove 174 while stroke in the −Y direction may be limited by the rear surface 192 of the front end portion 186 contacting the front surface 123 of the front wall 112 of the housing 110. As another non-limiting example, stroke in the +Y direction may be limited by the front surface 190 of the elongated portion 182 contacting the second seal 172 or the rear surface 125 of the front wall 112 while stroke in the −Y direction may be limited by the rib 194 contacting the rear end 178 of the groove 174. Additionally, as noted above, stroke in the +Y direction may be limited by the front surface 188 of the rear end portion 180 contacting the first seal 170 or the rear end 113 of the housing 110.

When the tow hook 104 is in the retracted position, the tow hook body 128 may not extend through the opening 106 formed in the bumper cover 108 such that the hole 134 formed in the tow hook body 128 is positioned rearward of the bumper cover 108. However, it should be appreciated that, in embodiments, the tow hook body 128 may extend through the opening 106 formed in the bumper cover 108 when in the retracted position, but less than an amount of which the tow hook body 128 extends through the opening 106 formed in the bumper cover 108 when the tow hook 104 is in the extended position.

To reposition the tow hook 104 into the extended position from the retracted position, the tow hook 104 may be pulled, for example, by a user gripping the front end 130 of the tow hook body 128 or utilizing a tool to engage the hole 134 formed in the tow hook body 128, and pulling the tow hook 104 back through the front aperture 122 formed in the housing 110 and through the opening 106 formed in the bumper cover 108 forward in the vehicle longitudinal direction, as depicted by arrow A2, which indicates the towing direction. In doing so, when the tow hook 104 is repositioned within the housing 110, the biasing member 154 forces the bearing 162 back into the detent 140 to retain the tow hook 104 in the extended position.

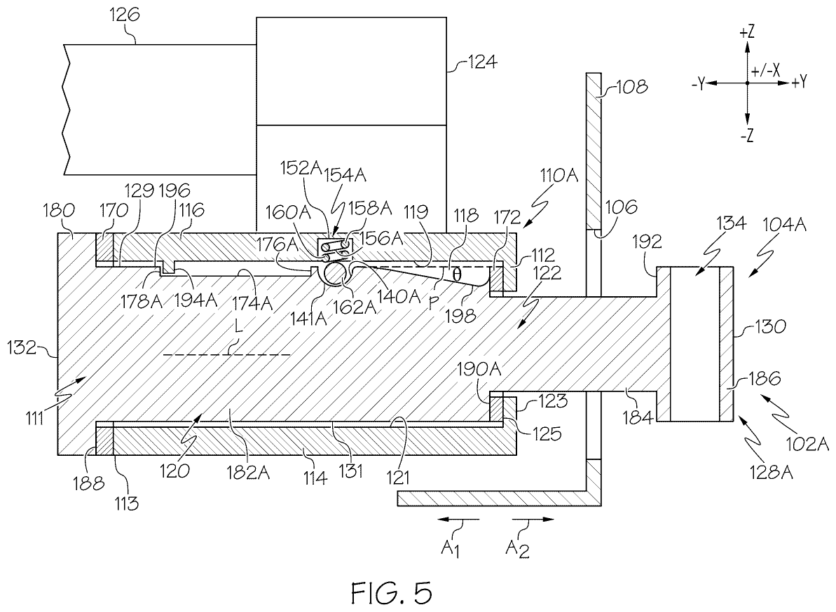

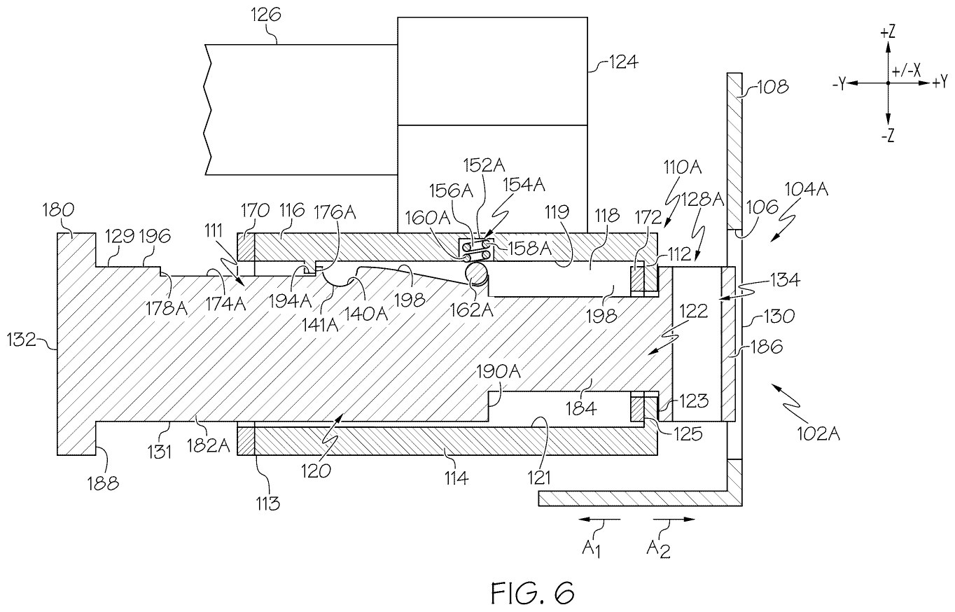

Referring now to FIGS. 5 and 6, another embodiment of a tow hook assembly 102A is depicted including a tow hook 104A and a housing 110A. It should be appreciated that the tow hook 104A and the housing 110A are substantially similar to the tow hook 104 and the housing 110, respectively, described herein and illustrated in FIG. 2. As such, like reference numbers will be used to describe like parts. However, rather than the detent 140 and the groove 174 being formed in the housing 110 and the rib 194 extending from the elongated portion 182 of the tow hook body 128, as described in the tow hook assembly 102 illustrated in FIG. 2, a detent 140A and a groove 174A are formed in the tow hook 104A and a rib 194A extends from the housing 110A. Additionally, rather than the biasing member 154 extending through the tow hook 104, as described in the tow hook assembly 102 illustrated in FIG. 2, a biasing member 154A is received within a biasing channel 152A formed in the housing 110A and extends into the detent 140A formed in the tow hook 104A.

With more particularity, as shown in FIG. 5, the tow hook assembly 102A includes the housing 110A and the tow hook 104A. The housing 110A includes the front wall 112, the lower wall 114, the upper wall 116 opposite the lower wall 114, and the pair of side walls 118 that define the open interior 120. In embodiments, the housing 110A is a one-piece, monolithic structure. In other embodiments, the upper wall 116 is separately attached to the front wall 112, the lower wall 114, and the pair of side walls 118. In other embodiments, each of the front wall 112, the lower wall 114, the upper wall 116, and the pair of side walls 118 are separately attached to one another. Accordingly, in embodiments, the housing 110A may not be a one-piece, monolithic structure. The rear aperture 111 is formed in the rear end 113 of the housing 110A, and the front aperture 122 is formed in the front wall 112 opposite the rear aperture 111 to permit the tow hook 104A to move between an extended position, as shown in FIG. 5, and a retracted position, as shown in FIG. 6, relative to the housing 110A. Accordingly, the rear aperture 111 and the front aperture 122 have any suitable geometry corresponding to a shape of the tow hook 104A, for example, circular, rectangular, or other regular or irregular shapes.

As shown in FIG. 5, the first seal 170 is provided on the rear end 113 of the housing 110A, and the second seal 172 is provided on the rear surface 125 of the front wall 112 of the housing 110A. In embodiments, the first seal 170 and the second seal 172 each extend along an entire inner surface of the housing 110A.

In embodiments, a biasing channel 152A is formed within the upper wall 116 of the housing 110A and extends partially through the upper wall 116 of the housing 110 in the vehicle vertical direction. In other embodiments, the biasing channel 152A is formed in the lower wall 114 of the housing 110A or, alternatively, in a side wall 118 of the housing 110A.

A biasing member 154A is received within the biasing channel 152A. In embodiments, the biasing member 154A includes a spring 156A having a first end 158A and a second end 160A opposite the first end 158A, and a bearing 162A provided at the second end 160A of the spring 156A. In embodiments, the spring 156A is a coil spring. In other embodiments, the spring 156A is a resilient elastomeric member such as a compressible rubber, resilient plastic, or the like.

In embodiments, the rib 194A extends from the inner surface 119 of the upper wall 116 of the housing 110. As shown in FIG. 5, the rib 194A is formed between the biasing channel 152A and the rear end 113 of the housing 110. However, in other embodiments, the rib 194A is formed between the biasing channel 152A and the front wall 112 of the housing 110.

Referring still to FIG. 5, the housing 110A is mounted to the frame member 124, such as the bumper beam, a crush box, or the like, in any suitable manner, for example, mechanical fasteners, clips, adhesive, welding, or the like. In embodiments, the upper wall 116 of the housing 110A is fixed to the frame member 124.

The tow hook 104A includes the tow hook body 128A having the front end 130 and the rear end 132 opposite the front end 130, the upper surface 129, and the lower surface 131 opposite the upper surface 129. In embodiments, the tow hook body 128A includes the rear end portion 192 formed at the rear end 132, an elongated portion 182A extending from the rear end portion 180, the neck portion 184 extending from the elongated portion 182A opposite the rear end portion 180, and the front end portion 186 formed at the front end 130 of the tow hook body 128A extending from the neck portion 184 opposite the elongated portion 182A.

As noted above, rather than the detent 140 being formed in the housing 110, as shown in FIG. 2, the detent 140A is formed in the tow hook 104A. As shown in FIG. 5, the detent 140A is formed on the upper surface 129 of the tow hook body 128A. In embodiments, the detent 140A defines a curved surface portion 141A facing the upper wall 116 of the housing 110A. It should be appreciated that the detent 140A may instead be formed on the lower surface 131 of the tow hook body 128A or one of the side surfaces of the tow hook body 128A. Additionally, in embodiments, a plurality of detents 140A may be formed in any combination of the upper surface 129, the lower surface 131, and/or the side surfaces of the tow hook body 128A.

In embodiments, an inclined surface 198 extends from the detent 140A toward a front surface 190A of the elongated portion 182A. The inclined surface 198 is oriented at an acute angle θ relative to a longitudinal plane P of the upper surface 129 of the tow hook body 128A extending parallel to a longitudinal axis L of the tow hook 104A, i.e., parallel to the vehicle longitudinal direction. In embodiments, the acute angle θ is 20 degrees +/−10%. In embodiments, the acute angle θ is 20 degrees +/−20%. In embodiments, the acute angle θ is 20 degrees +/−30%. In embodiments, the acute angle θ is 20 degrees +/−40%. In embodiments, the acute angle θ is 20 degrees +/−50%. Additionally, the inclined surface 198 tapers inwardly toward the longitudinal axis L in a direction from the detent 140A toward the front surface 190A of the elongated portion 182A.

As shown in FIG. 5, the groove 174A is formed on the upper surface 196 of the elongated portion 182A of the tow hook body 128A. It should be appreciated that the groove 174 may instead be formed on a lower surface of the elongated portion 182A of the tow hook body 128A or one of the side surfaces of the tow hook body 128A. Additionally, in embodiments, a plurality of grooves 174A may be formed in any combination of the upper surface 129, the lower surface 131, and/or the side surfaces of the tow hook body 128A. The groove 174A extends parallel to the vehicle longitudinal direction and has a front end 176A and a rear end 178A opposite the front end 176A. The front end 176A of the groove 174A is closer to the front end 130 of the tow hook body 128A, and the rear end 178A of the groove 174A is closer to the rear end 132 of the tow hook body 128A. As shown, the groove 174A is formed between the detent 140A and the rear end 132 of the tow hook body 128A. However, in other embodiments, it should be appreciated that the groove 174A may be formed between the detent 140A and the front end 130 of the tow hook body 128A.

As shown in FIG. 5, when the tow hook 104A is in the extended position, the first seal 170 provided on the rear end 113 of the housing 110A abuts against the front surface 188 of the rear end portion 180 of the tow hook body 128A, and the second seal 172 provided on the rear surface 125 of the front wall 112 of the housing 110A abuts against the front surface 190A of the elongated portion 182A of the tow hook body 128A.

Moreover, as shown in FIG. 5, when the tow hook 104A is in the extended position, the spring 156A of the biasing member 154A forces the bearing 162A into the detent 140A. Additionally, when the tow hook 104A is in the extended position, the rib 194A abuts against the rear end 178A of the groove 174A. Accordingly, it should be appreciated that the stroke of the tow hook 104A in the +Y direction relative to the housing 110A is limited by contact of the front surface 188 of the rear end portion 180 with the first seal 170, contact of the front surface 190A of the elongated portion 182A with the rear surface 125 of the front wall 112 of the housing 110A, and/or contact of the rib 194A with the rear end 178A of the groove 174A.

Similar to operation of the tow hook assembly 102 illustrated in FIG. 2 and described herein, when a force is applied against the front end 130 of the tow hook body 128A exceeding a predetermined threshold, the tow hook 104A moves in the direction of arrow A1. Such movement causes the spring 156A to compress, allowing the bearing 162A to move out of the detent 140A, and slide along the inclined surface 198. The spring 156A forces the bearing 162A along the inclined surface 198 drawing the tow hook in the direction of arrow A1.

As shown in FIG. 6, when the tow hook 104A is in the retracted position, the rear surface 192 of the front end portion 186 abuts against the front surface 123 of the front wall 112 of the housing 110A. Additionally, when the tow hook 104A is in in the retracted position, the rib 194A abuts against the front end 176A of the groove 174A. Accordingly, it should be appreciated that the stroke of the tow hook 104A in the −Y direction relative to the housing 110A is limited by contact of the rear surface 192 of the front end portion 186 of the tow hook body 128A with the front surface 123 of the front wall 112 of the housing 110A and/or contact of the rib 194A with the front end 176A of the groove 174A.

As described herein with respect to the tow hook 104 illustrated in FIG. 2, the tow hook 104A is permitted to move in the direction of arrow A2 to return to the extended position by manual operation by a user. During movement of the tow hook 104A toward the extended position, the spring 156A compresses, allowing the bearing 162A to slide along the inclined surface 198. Once the tow hook 104A has moved into the extended position, the spring 156A is permitted to extend and move the bearing 162A into the detent 140A, thereby locking the tow hook 104A in the extended position, as shown in FIG. 5.

From the above, it is to be appreciated that defined herein is a tow hook assembly including a housing having a front aperture formed in a front wall of the housing, a tow hook at least partially extending through the front aperture and movable between an extended position and a retracted position, and a biasing member prohibiting movement of the tow hook from the extended position to the retracted position until a force exceeding a predetermined force threshold is applied against a front end of the tow hook.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A tow hook assembly comprising:
a housing including a front wall, a front aperture formed in the front wall, and a detent formed in an inner surface of the housing, the detent defining a curved surface portion; and
a tow hook at least partially extending through the front aperture of the housing, the tow hook movable between an extended position and a retracted position relative to the housing, the tow hook including a biasing member received within a biasing channel formed in the tow hook and a bearing provided at an end of the biasing member, the biasing member biasing the bearing into the detent when the tow hook is in the extended position, the biasing member prohibiting movement of the tow hook from the extended position to the retracted position until a force exceeding a predetermined force threshold in a direction opposite a towing direction is applied against a front end of the tow hook.

2. The tow hook assembly of claim 1, wherein, when the tow hook is in the extended position, the tow hook extends farther outward from the housing than when the tow hook is in the retracted position.

3. The tow hook assembly of claim 1, wherein the curved surface portion faces the front aperture.

4. The tow hook assembly of claim 1, wherein the curved surface portion of the detent extends to an inner surface of an upper wall of the housing.

5. The tow hook assembly of claim 1, wherein the curved surface portion extends substantially half a length of the detent in a vehicle longitudinal direction.

6. The tow hook assembly of claim 1, wherein the curved surface portion has a curvature corresponding to a curvature of the bearing.

7. The tow hook assembly of claim 1, wherein the tow hook comprises a tow hook body including a rear end portion, an elongated portion extending from a front surface of the rear end portion, a front end portion, and a neck portion extending from a front surface of the elongated portion and a rear surface of the front end portion, wherein the biasing channel is formed in the elongated portion, and wherein a height of the elongated portion in a vehicle vertical direction is greater than a height of the neck portion in the vehicle vertical direction.

8. The tow hook assembly of claim 7, wherein a height of the rear end portion in the vehicle vertical direction is greater than the height of the elongated portion, and a height of the front end portion in the vehicle vertical direction is greater than the height of the neck portion.

9. The tow hook assembly of claim 7, wherein, when in the retracted position, the rear surface of the front end portion abuts against a front surface of the front wall of the housing.

10. The tow hook assembly of claim 9, wherein, when in the extended position, the front surface of the rear end portion abuts against a rear end of the housing.

11. The tow hook assembly of claim 9, wherein, when in the extended position, the front surface of the elongated portion abuts against a rear surface of the front wall of the housing.

12. The tow hook assembly of claim 1, wherein the detent is formed in an upper wall of the housing closer to the front wall of the housing than to a rear end of the housing.

13. The tow hook assembly of claim 1, wherein the predetermined force threshold is 1 kN +/−50%.
